(19) United States
(12) Patent Application Publication
(10) Pub. No.: US 2022/0219848 A1
(43) Pub. Date: Jul. 14, 2022

(54) PRESERVATION METHOD FOR ROOM TEMPERATURE LOGISTICS OF FRESH PORK

(71) Applicant: ZHEJIANG UNIVERSITY, Hangzhou, Zhejiang (CN)

(72) Inventors: Daxi Ren, Hangzhou (CN); Yanran Zhang, Hangzhou (CN); Chenxing Liu, Hangzhou (CN); Youliang Chen, Hangzhou (CN); Dongwen Hu, Hangzho (CN); Ziyi Hu, Hangzhou (CN); Wei Chen, Hangzhou (CN); Jianxin Liu, Hangzhou (CN)

(21) Appl. No.: 17/158,649

(22) PCT Filed: Jun. 29, 2020
(86) PCT No.: PCT/CN2020/098765

§ 371 Date: Jan. 26, 2021

(30) Foreign Application Priority Data
Jun. 29, 2019 (CN) 201910580895.3

(51) Int. Cl. B65B 25/06; A23B 4/06; A23B 4/16; B65B 31/04; B65B 5/06; B65B 61/22; A22C 17/00

(52) U.S. Cl. CPC B65B 25/067; A23B 4/06; A23B 4/16; A23V 2002/00; B65B 5/06; B65B 61/22; A22C 17/002; B65B 31/04

(57) ABSTRACT

The present disclosure provides a preservation method for room temperature logistics of fresh meat, e.g., pork, including the following steps: cutting a slaughtered pig into pieces while the pork is hot, and cooling to 0° C. to 4° C.; cooling again to −4° C. to −2° C. so that the meat pieces reach a chilled/slightly-frozen state; sub-packaging the chilled/slightly-frozen meat pieces; putting sub-packaging boxes with fresh meat pieces into an insulation foam box together with ice bags for packaging; and using a room temperature logistics vehicle for transportation and distribution, where, when in an ambient temperature is at least 24° C. (e.g., summer), transportation and distribution time is ≤36 h; and when the ambient temperature is less than 24° C. (e.g., spring, autumn, and winter), the transportation and distribution time is ≤72 h.

### CROSS-REFERENCE TO RELATED APPLICATIONS

The present application claims priority to the Chinese Patent Application CN201910580895.3, filed to the China National Intellectual Property Administration (CNIPA) on Jun. 29, 2019 and entitled “PRESERVATION METHOD FOR ROOM TEMPERATURE LOGISTICS OF FRESH PORK”, which is incorporated herein by reference in its entirety.

### BACKGROUND

### Technical Field

The present disclosure relates generally to the field of room temperature logistics of raw meat, and more particularly fresh pork, and in particular to a preservation method of a method for room temperature logistics of fresh pork in an electronic business (e-business).

### Description of the Related Art

Raw meat is mainly sold in three forms in China, namely, fresh meat, frozen meat, and chilled meat. Chilled meat, also known as cooled meat, has a promising market prospect due to its advantages, such as a high safety factor and a high nutritional value. There are relatively high requirements for a temperature during the transportation of chilled meat. Technologies used for low-temperature meat products and room-temperature meat products in commercial logistics are respectively specified in the national standard GB/T 21735-2008 “Meat and Meat Products Logistics Specification” issued on May 7, 2008, which discloses, for example that the transportation and temporary storage of room-temperature meat products require a temperature not higher than 25° C. However, the imperfect cold chain logistics system in China can only achieve a transportation rate lower than 20%, as compared to roughly 90% in developed countries.

The transportation of fresh meat in an e-business relies on logistics for managing room temperature. Often, fresh meat is packaged and transported in foam insulation boxes that are filled with ice bags. At present, in e-business and specialty stores, fresh meat is treated and distributed as follows: (a) the entire slaughtered animal, e.g., a pig, is cooled and aged (e.g., the entire slaughtered pig is cooled overnight in a cold zone and aged); (b) the post-mortem aged pork is cut and packaged at 0° C. to 4° C.; (c) vacuum packaged or modified atmosphere packaged (MAP) meat samples are placed in the foam boxes together with ice bags, and resulting boxes are then sealed, packaged, and distributed, so that the temperature of chilled meat can be continuously maintained below 25° C. during logistics transportation; and (d) the transportation time cannot exceed 3 days (not more than 1.5 days in summer). Due to the high temperature during distribution, the insulation effect for fresh meat (e.g., pork) is poor during transportation, which leads to deterioration of the meat (e.g., pork) during the distribution, thus resulting in large loss due to spoilage. Therefore, there is a need for a fresh pork distribution and preservation technology at room temperature for different seasons to provide technical support for the development of improved logistics and distribution methods for pork in e-business.

### SUMMARY

The present disclosure is intended to provide a preservation method for room temperature logistics of fresh pork. The method provided by the present disclosure leads to an excellent insulation effect, and can significantly improve the fresh meat quality in room temperature logistics and extend the shelf life of fresh meat.

To achieve the above purposes, the present disclosure provides the following technical solution.

In an exemplary embodiment of the present disclosure, a preservation method for room temperature logistics of fresh meat may include the following steps: (S1) cooling and cutting of fresh meat, including: (a) cutting the fresh meat while the fresh meat is hot into meat pieces; (b) cooling each of the meat pieces to a center temperature of 0° C. to 4° C. within 2 hours to 3 hours, each the meat pieces having a weight of 0.5 kg/piece to 1 kg/piece; (S2) cooling the meat pieces to a chilled/slightly-frozen state, including: (a) cooling the meat pieces to a center temperature of −4° C. to −2° C. so that the pork pieces reach a chilled/slightly-frozen state; (S3) sub-packaging, including: (a) placing a layer of absorbent pad at the bottom of a sub-packaging box; (b) wrapping the meat pieces that have been cooled to the chilled/slightly frozen state; and (c) conducting vacuum-packaging or modified atmosphere packaging (MAP) of the meat pieces; (S4) packaging, including: (a) providing one or more insulation foam packaging boxes having one or more walls, wherein when ambient temperature is at least 24° C., the one or more walls of each of the insulation foam boxes has a thickness of 2 cm to 3 cm, an insulation layer being disposed on an inner surface of the insulation foam box, wherein when ambient temperature is below 24° C., the one or more walls of each of the one or more insulation foam boxes has a thickness of 1.5 cm to 2 cm; (b) placing the sub-packaging boxes containing the meat pieces into the one or more insulation foam packaging boxes together with ice bags, the ice bags and the meat pieces in the sub-packaging boxes having a weight ratio having a value of 2:1 to 1:1, a total volume of the ice bags and the sub-packaging boxes being 90% to 100% of a volume of the insulation foam box; (c) when ambient temperature is below 24° C., putting the sub-packaging boxes containing the meat pieces into the one or more insulation foam boxes together with ice bags, the ice bags and the meat pieces in the sub-packaging boxes have a weight ratio having a value of 0.5:1 to 1:1, a total volume of the ice bags and the sub-packaging boxes with fresh pork pieces is 90% to 100% of a volume of the one or more insulation foam boxes; (S5) logistics, including: (a) using a room temperature logistics vehicle for transportation and distribution, wherein, (b) when in ambient temperature is at least 24° C., transportation and distribution time is ≤36 h; and (c) when ambient temperature is less than 24° C., the transportation and distribution time is ≤72 h.

The absorbent pad may include a wood pulp-wrapped polyethylene (PE)-super absorbent resin (SAR) mixture or nonwoven fabric-wrapped PE; and the absorbent pad has a thickness of 0.1 cm to 0.3 cm.

The packaging gas in the MAP may include the following components, in volume percentage: 80% O₂, 15% CO₂, and 5% N₂; and the packaging gas in the MAP has a replacement rate ≥99.5%.

The insulation layer may have a thickness of 0.5 cm to 1 cm and/or may be formed from a material including aluminum silicate fiber cotton.

When the transportation and distribution time exceeds 16 h, a cooling treatment may be conducted, the cooling treatment may include: opening the one or more insulation foam packaging boxes; re-cooling the fresh pork pieces in sub-packaging boxes until the center temperature of the pork pieces is ≤4° C.; and replacing the original ice bags with new ice bags and re-packaging the foam packaging box.

When the transportation and distribution time exceeds 16 h, a cooling treatment may be conducted, the cooling treatment comprising: opening the one or more insulation foam packaging boxes; re-cooling the fresh pork pieces in sub-packaging boxes until the center temperature of the pork pieces is ≤4° C.; and replacing the original ice bags with new ice bags and re-packaging the one or more foam packaging boxes.

These and other aspects of the present disclosure are more fully described in detail hereinbelow.

### DETAILED DESCRIPTION

The present disclosure is further described below with reference to examples.

The present disclosure provides a preservation method for room temperature logistics of fresh pork. A first step (S1) may include cooling and cutting pork. For example, a slaughtered pig may be cut into pieces while the pork is hot. The cut pork pieces that are obtained from the cutting may each weigh between 0.5 kg and 1 kg, inclusive. Depending on the weight of the cut pieces, the cut pieces may be cooled to have a center temperature of 0° C. to 4° C. within 2 hours to 3 hours. In the present disclosure, the cooled center temperature of the cut pieces may preferably be 1° C. to 3° C. and more preferably 2° C. In the present disclosure, the pork pieces may preferably have a weight of 0.6 kg/piece to 0.9 kg/piece, and more preferably of 0.7 kg/piece to 0.8 kg/piece.

A second step (S2) may include cooling the cut pieces to a chilled or a slightly-frozen state. For example, the pork pieces obtained in step S1 may be further cooled to have a center temperature of −4° C. to −2° C. so that the pork pieces reach a chilled or slightly-frozen state. In the present disclosure, the pork pieces obtained from cutting may preferably be placed in a freezer for cooling. The freezer may have a temperature preferably of −20° C. and the cooling may be conducted preferably for 2 hours to 4 hours, more preferably for 2.5 h to 3.5 h, and most preferably for 3 h. In the present disclosure, the pork pieces may have a center temperature that is preferably of −3.5° C. to −2.5° C. and more preferably of −3° C.

A third step (S3) may include sub-packaging. For example, a layer of absorbent pad may be placed at the bottom of a sub-packaging box. The chilled/slightly-frozen pork piece(s) that were obtained in step S2 may be wrapped with plastic wrap. For example, the chilled/slightly-frozen pork piece(s) may be vacuum-packaging or MAP and may be placed in the sub-packaging boxes in which the layer of absorbent pad had been placed.

In the present disclosure, the sub-packaging box may preferably be a plastic box, but is not limited thereto. The sub-packaging box preferably is sized to accommodate the absorbent pad and the chilled/slightly frozen pork piece(s) therein. It should be noted that any dimensions discussed herein are exemplary and are provided by way of description and are not intended to limit the sub-packaging box to any particular dimensions. In the present disclosure, the absorbent pad may have a thickness that is preferably 0.1 cm to 0.3 cm, inclusive, and more preferably between 0.15 cm to 0.2 cm, inclusive. In the present disclosure, the absorbent pad may preferably include food-grade polyethylene film (PE film), nonwoven fabric and/or a combination or mixture of PE, super absorbent polymer (SAP), and/or wood pulp. The PE film discussed herein may be manufactured, for example, by Shenzhen Miyuan New Material Technology Co., Ltd.). Other materials or combinations of materials may include PE/absorbent resin/nonwoven fabric and PE/nonwoven fabric. Such materials may materials (e.g., PE, absorbent resin, nonwoven fabric, and/or PE/nonwoven fabric) that are manufactured by Shenzhen Xianmeihui New Material Technology Co., Ltd. Other combinations of materials may include PE/SAP/wood pulp, which may include materials that are manufactured by Beijing Shengshi Yongjin Trading Co., Ltd. For the vacuum sealed packages, a vacuum gauge for the vacuum packaging may have a scale preferably of −0.1. In the present disclosure, a packaging gas in the MAP may preferably include the following components, in volume percentage: 80% O₂, 15% CO₂, and 5% N₂; and the packaging gas in the MAP may preferably have a replacement rate ≥99.5%. The operation of vacuum packaging or MAP and an operation of vacuum packaging or MAP may be performed by any suitable means as might be known to those skilled in the art.

A fourth step (S4) may include packaging the sub-packaging boxes into another box. For example, in the present disclosure, during the summer months (e.g., June to August or on days when average temperature is 24° C. or greater, in other words on days when the ambient/environmental temperature is expected to be 24° C. or greater), the sub-packaging boxes with fresh pork pieces are put into an insulation foam box together with ice bags. The ice bags and the pork pieces in the sub-packaging boxes may have a weight ratio that is between 2:1 and 1:1 inclusive. In the present disclosure, the ice bags and the pork pieces in the sub-packaging boxes may have a weight ratio more preferably of 1.8:1 to 1.2):1 and more preferably of 1.5:1 to 1.4:1. The insulation foam box may have a thickness of 2 cm to 3 cm. In the present disclosure, the insulation foam box may preferably have a thickness more of 2.2 cm to 2.8 cm and more preferably of 2.5 cm to 2.6 cm. An insulation layer may be disposed on an inner surface of the insulation foam box. A total volume of the ice bags and the sub-packaging boxes with fresh pork pieces may be 90% to 100% of a volume of the insulation foam box. In the present disclosure, the total volume of the ice bags and the sub-packaging boxes with fresh pork pieces may be preferably 92% to 98%, preferably 94% to 96%, and more preferably 95% of the volume of the insulation foam box.

In the present disclosure, the inner surface may preferably include may define a generally rectangular shape that includes a top surface, and a bottom surface, and four sides that each extend between the top surface and the bottom surface. In the present disclosure, the insulation layer may preferably be aluminum silicate fiber cotton. The insulation layer may have a thickness preferably of 0.5 cm to 1 cm, preferably of 0.6 cm to 0.9 cm, and more preferably of 0.7 cm to 0.8 cm.

In the present disclosure, when in spring, autumn, and winter (or on days when the average temperature is below 24° C., in other words on days when the ambient/environmental temperature is expected to be 24° C. or lower), the sub-packaging boxes with fresh pork pieces are put into an insulation foam box together with ice bags, where, the ice bags and the pork pieces in the sub-packaging boxes may have a weight ratio of 0.5:1 to 1):1. The insulation foam box may have a thickness of 1.5 cm to 2 cm. A total volume of the ice bags and the sub-packaging boxes with fresh pork pieces may be 90% to 100% of a volume of the insulation foam box.

In the present disclosure, the ice bags and the pork pieces in the sub-packaging boxes may have a weight ratio that is preferably between 0.6:1 and 0.9:1 inclusive, and more preferably between 0.7:1 and 0.8:1 inclusive. In the present disclosure, the insulation foam box may have a thickness that is between 1.6 cm and 1.9 cm inclusive and more preferably of 1.7 cm to 1.8 cm. In the present disclosure, the total volume of the ice bags and the sub-packaging boxes with fresh pork pieces may be 92% to 98%, preferably 94% to 96%, and more preferably 95% of the volume of the insulation foam box.

In the present disclosure, after the sub-packaging boxes with fresh pork pieces and the ice bags are filled, the foam packaging boxes are packaged. It should be understood that the particular embodiments of a method of the packaging that are disclosed herein are merely exemplary and are not meant to be limited thereto as other packaging methods of the foam packaging box may be within the scope and spirit of the present disclosure. In the present disclosure, the space in the foam packaging box may preferably be filled as much as possible, so as to reduce air circulation and ensure the insulation effect. In the present disclosure, the filled space in the foam packaging box may have a volume preferably 70% to 95% and more preferably 85% to 95% of a volume of the foam packaging box.

A fifth step (S5) may include logistics for maintaining the temperature of the meat and for transporting the meat. For example, a room temperature logistics vehicle may be used for transportation and distribution. In the summer months, for example, transportation and distribution time may be 36 or fewer hours. In contrast, during the colder months, e.g., spring, autumn, and winter, the transportation and distribution time may be 72 or fewer hours. In the present disclosure, the room temperature logistics vehicle may have a temperature that is between 5° C. and 40° C. inclusive, preferably between 10° C. and 35° C. inclusive, and more preferably of 15° C. to 30° C. During the summer, the transportation and distribution time may be more preferably 1 hour to 30 hours, more preferably 5 hours to 25 hours, and more preferably 10 hours to 20 hours. In the present disclosure, in winter, the transportation and distribution time may be 10 hours to 70 hours, more preferably 30 hours to 60 hours, and more preferably 40 hours to 50 hours.

In the present disclosure, when the transportation and distribution time is more than 16 hours, the fresh pork pieces in the sub-packaging boxes in the foam packaging box may preferably be subjected to a cooling treatment. In the present disclosure, the cooling treatment may preferably include the following steps: opening the foam packaging box; re-cooling the fresh pork pieces in sub-packaging boxes to a specified center temperature; and replacing the original ice bags with new ice bags, and re-packaging the foam packaging box. In the present disclosure, the center temperature may be preferably ≤4° C., more preferably 0° C. to 3° C., and even more preferably 1° C. to 2° C. In the present disclosure, the cooling may be preferably conducted in a freezer, and the freezer may have a temperature preferably of −20° C. In the present disclosure, the cooling treatment may preferably be conducted at a distribution point.

The technical solutions of the present disclosure relate to a pork thermal cutting technology, a chilling and/or slightly-freezing technology, vacuum packaging/MAP, an absorbent pad, a foam insulation box, an ice bag, aluminum silicate fiber cotton, and the like. The absorbent pad is used to absorb the moisture exuded from pork during distribution and transportation.

Advantageously, since the freezing point of fresh pork is around −2° C., the meat will not be completely frozen at −4° C. to −2° C., the fresh meat obtained by using the present disclosure has a taste and quality that are basically the same as that of ordinary chilled meat.

The method provided in the present disclosure has the following advantages: (1) The present disclosure adopts aluminum silicate fiber cotton as a thermal insulation material, which has an excellent insulation effect and can significantly improve the quality of fresh meat, e.g., fresh pork, in room temperature logistics. (2) The present disclosure adopts the thermal cutting technology followed by cooling, which can effectively extend the shelf life of fresh meat. (3) The present disclosure improves the cooling temperature: fresh meat is usually packaged at 0° C. to 4° C., and after the improvement in the present disclosure, a chilling/slightly-freezing temperature of −4° C. to −2° C. is adopted to significantly improve the quality of fresh pork in room temperature logistics.

Advantageously, the method of the present disclosure can improve the insulation effect of fresh meat in room temperature logistics, reduce the logistics loss of fresh meat, and improve the quality and extend the shelf life of fresh meat. That is, the present disclosure combines improvements of various technical means to improve the preservation of pork in room temperature logistics, thus contributing to the on-line sale and distribution of pork in e-business and other companies.

### Example 1

In a first example, the first step (S1) of cooling and cutting the pork included: cutting still hot pork into pieces that each have a weight of 0.5 kg/piece to 1 kg/piece and cooling the pieces to 0° C. to 4° C. (the center temperature of the pork piece) within 2 hours to 3 hours.

The second step (S2) of cooling the pork pieces to a chilled/slightly-frozen state included placing the pork pieces that were obtained from the cutting in S1 were cooled to a center temperature of −4° C. to −2° C. in a freezer (−20° C.) so that the pork pieces reached a slightly-frozen/chilled state.

The third step (S3) of sub-packaging the pork pieces included placing a layer of absorbent pad at the bottom of a sub-packaging box (e.g., a small plastic box) and placing a pork piece that was wrapped with plastic wrap, for example, into the box. The wrapped pork pieces may be vacuum-packaged to ensure freshness. During the vacuum packaging, the scale of the vacuum gauge reached a vacuum pressure of −0.1 MPa.

The fourth step (S4) of packaging included using foam packaging boxes were used for packaging. An insulation foam box may have a thickness of 3 cm. An insulation layer was disposed on an inner surface, which formed a generally rectangular shape that included four sides, a top surface, and a bottom surface, of the insulation foam box. The insulation layer was formed from a material including aluminum silicate fiber cotton and had a thickness of 1 cm. According to an ice bag/meat weight ratio of 1:1, the sub-packaging boxes with fresh pork pieces were placed into the insulation foam box together with ice bags. A total volume of the ice bags and the sub-packaging boxes with fresh pork pieces was 90% to 100% of a volume of the insulation foam box. After the sub-packaging boxes with fresh pork pieces and the ice bags were filled, the foam packaging boxes were packaged using a conventional packaging method for foam packaging boxes.

The fifth step (S5) of logistics included providing a room temperature logistics vehicle for transportation and distribution of the packaged, fresh meat at a temperature of 35° C. The total volatile basic nitrogen (TVB-N) and the aerobic plate count (APC) in the fresh pork were detected at different distribution time points.

### Comparative Example 1

A sample subjected to a conventional vacuum packaging operation in which the pork pieces were wrapped with plastic wrap and then vacuum packaged. A scale of the vacuum gauge reached −0.1 MPa was adopted as a control.

As described above with reference to Example 1, a pig carcass (the same as Example 1) was cooled and aged for 24 h, cut at 0° C. to 4° C., and then vacuum packaged, with an absorbent pad being added; a vacuum packaged pork piece was placed in an insulation foam box together with ice bags and sealed; and a logistics vehicle was used for transportation and distribution.

To test the TVB-N and APC in the fresh pork pieces transported in Example 1 and Comparative Example 1 at different distribution time points, a TVB-N detection method according to GB 5009.228-2016 “National Food Safety Standard: Determination of Total Volatile Basic Nitrogen (TVB-N) in Foods” was adopted, and an APC detection method according to GB 4789.2-2016 “National Food Safety Standard: Food Microbiological Examination: Aerobic Plate Count (APC)” was adopted.

The detection method may include the following steps as were conducted in the Comparative Example 1. In the Comparative Example 1, the total volatile basic nitrogen (TVB-N) was detected by a semi-microtitration method, in which: 20 g of a sample was taken and added to 2% trichloroacetic acid (TCAA); a resulting mixture was centrifuged at 5,000 rpm for 1 min; a resulting supernatant was filtered with filter paper; and a resulting filtrate was titrated with 1% MgO₂. The TVB-N was absorbed with 2% boric acid, and then titrated with a 0.01 N HCl solution. The results of TVB-N were represented in unit of mg/100 g. A mixture of a solution of bromocresol green (BCG) in ethanol and a solution of methylene blue (MB) in ethanol was used as an indicator for titration end-point.

Allophycocyanin (APC) detection: 25 g of pork was cut with sterilized scissors and put into a sterile bag, 225 mL of normal saline that had been sterilized at 121° C. for 15 min and then cooled was poured, and the pork was beaten with a beating homogenizer for 2 min to obtain a 1:10 homogenized sample. A 10-fold serial dilution method was used for dilution. 1 mL of a bacterial liquid was added to a test tube with 9 mL of sterile normal saline, and a resulting mixture was thoroughly shaken. 1 mL of the homogenized sample at an appropriate dilution was pipetted with a sterile pipette tip and added to a dish with 15 mL to 20 mL of 46° C. sterile PCA plate counting agar medium (Beijing Luqiao); and the dish was rotated for thorough mixing, and incubated in a 36° C. incubator for 48 h after the agar was solidified. Two blank controls were set for each experiment; 3 dilutions were selected for each experimental sample; and three replicates were used for each dilution. The APC was represented in unit of Log CFU/g.

The specific detection results of Example 1 and Comparative Example 1 at different time points are shown in Table 1 below.

TABLE 1
Preservation effect of vacuum packaged fresh pork in 35° C. distribution

| | TVB-N (mg/100 g) | | APC (Log CFU/g) | |
|---|---|---|---|---|
| | sample of the | conventional sample | sample of the | conventional sample |
| Time | present disclosure | (Comparative | present disclosure | (Comparative |
| point | (Example 1) | Example 1) | (Example 1) | Example 1) |
| 24 h | 7.53 ± 0.12 | 13.43 ± 0.15 | 4.67 | 5.16 |
| 36 h | 10.33 ± 0.19 | 17.11 ± 0.15 | 5.32 | 6.23 |
| 48 h | 15.27 ± 0.25 | Not detected | 5.92 | Not detected |

Notes:
According to GB 5009.228-2016 and GB 4789.2-2016, when TVB-N > 15 mg/100 g or APC > 6 Log CFU/g, the meat is not fresh.

It can be seen from Table 1 that, for fresh pork using the ordinary preservation method (Comparative Example 1), the TVB-N exceeded 15 mg/100 g and the APC exceeded 6 Log CFU/g at 30 h, higher than that specified in the national standard; and fresh pork using the solution of the present disclosure could achieve a freshness lifetime reaching about 48 h during distribution, greatly reducing the loss during distribution.

### Example 2

According to Example 2, the preservation was conducted according to the method in Example 1 except that the vacuum packaging in step S3 of Example 1 was changed to MAP (a packaging gas of the MAP had the following components, in volume percentage: 80% O₂, 15% CO₂, and 5% N₂), with a gas replacement rate ≥99.5%.

### Comparative Example 2

According to Comparative Example 2, a sample subjected to the conventional MAP operation (a packaging gas of the MAP had the following components, in volume percentage: 80% O₂, 15% CO₂, and 5% N₂, with a gas replacement rate ≥99.5%) was adopted as a control.

The TVB-N and the APC in the fresh pork pieces were detected according to the above methods. Detection results are shown in Table 2 below.

TABLE 2
Preservation effect of MAP fresh pork in 35° C. distribution

| | TVB-N (15 mg/100 g) | | APC (Log CFU/g) | |
|---|---|---|---|---|
| | sample of the | conventional sample | sample of the | conventional sample |
| Time | present disclosure | (Comparative | present disclosure | (Comparative |
| point | (Example 2) | Example 2) | (Example 2) | Example 2) |
| 24 h | 8.99 ± 0.15 | 15.23 ± 0.15 | 4.67 | 6.17 |
| 36 h | 13.43 ± 0.19 | Not detected | 6.01 | Not detected |
| 48 h | 20.55 ± 0.25 | Not detected | Not detected | Not detected |

It can be seen from Table 2 that, for fresh pork using the ordinary solution (Comparative Example 2), the TVB-N exceeded 15 mg/100 g and the APC exceeded 6 Log CFU/g at 24 h, higher than that specified in the national standard; and fresh pork using the solution of the present disclosure could achieve a freshness lifetime more than 36 hours, greatly reducing the loss during distribution.

### Example 3

In Example 3, Steps 51 to S3 were the same as in Example 1. In Step S4, packaging included providing foam packaging boxes that were used for packaging. The insulation foam box had a thickness of 2 cm. According to an ice bag/meat weight ratio of 1:1, the sub-packaging boxes with fresh pork pieces were placed into the insulation foam box together with ice bags. A total volume of the ice bags and the sub-packaging boxes with fresh pork pieces was 90% to 100% of a volume of the insulation foam box.

After the sub-packaging boxes with fresh pork pieces and the ice bags were filled, the foam packaging boxes were packaged using a conventional packaging method for foam packaging boxes. S5. Logistics: A room temperature logistics vehicle was used for transportation and distribution at 20° C. The TVB-N and the APC in fresh pork pieces were detected at different distribution time points.

### Comparative Example 3

According to Comparative Example 3, a sample was subjected to a vacuum packaging operation in which the pork pieces were wrapped with plastic wrap and then vacuum packaged and a scale of the vacuum gauge reached −0.1 MPa was adopted as a control. The TVB-N and the APC in the fresh pork pieces were detected according to the above methods. Detection results are shown in Table 3 below.

TABLE 3
Preservation effect of MAP fresh pork in 20° C. distribution

| | TVB-N (15 mg/100 g) | | APC (Log CFU/g) | |
|---|---|---|---|---|
| | sample of the | conventional sample | sample of the | conventional sample |
| Time | present disclosure | (Comparative | present disclosure | (Comparative |
| point | (Example 3) | Example 3) | (Example 3) | Example 3) |
| 24 h | 6.17 ± 0.55 | 8.35 ± 0.32 | 4.36 ± 0.12 | 4.88 ± 0.15 |
| 48 h | 7.73 ± 0.09 | 13.25 ± 0.49 | 5.05 ± 0.21 | 5.51 ± 0.22 |
| 72 h | 11.83 ± 0.25 | 19.6 ± 0.35 | 5.81 ± 0.25 | 6.83 ± 0.34 |
| 96 h | 15.71 ± 0.25 | Not detected | 6.37 ± 0.33 | Not detected |

In Comparative Example 3, as shown in Table 3, for fresh pork, the TVB-N exceeded 15 mg/100 g and the APC exceeded 6 Log CFU/g at 56 h, higher than that specified in the national standard; and fresh pork using the solution of the present disclosure could achieve a freshness lifetime up to about 84 hours.

### Example 4

In Example 4, the preservation was conducted according to the method in Example 3 except that the vacuum packaging in step S3 of Example 3 was changed to MAP in which a packaging gas of the MAP had the following components, in volume percentage: 80% O₂, 15% CO₂, and 5% N₂, with a gas replacement rate ≥99.5%.

### Comparative Example 4

In Comparative Example 4, a sample subjected to the conventional MAP operation in which a packaging gas of the MAP had the following components, in volume percentage: 80% O₂, 15% CO₂, and 5% N₂, with a gas replacement rate ≥99.5% was adopted as a control. The TVB-N and the APC in the fresh pork pieces were detected according to the above methods. Detection results are shown in Table 4 below.

TABLE 4
Preservation effect of MAP fresh pork in 20° C. distribution

| | TVB-N (15 mg/100 g) | | APC (Log CFU/g) | |
|---|---|---|---|---|
| | sample of the | conventional sample | sample of the | conventional sample |
| Time | present disclosure | (Comparative | present disclosure | (Comparative |
| point | (Example 4) | Example 4) | (Example 4) | Example 4) |
| 24 h | 6.87 ± 0.35 | 9.15 ± 0.32 | 4.66 ± 0.11 | 5.18 ± 0.19 |
| 48 h | 9.73 ± 0.09 | 15.15 ± 0.49 | 5.45 ± 0.29 | 6.23 ± 0.24 |
| 72 h | 13.83 ± 0.25 | 22.61 ± 0.35 | 6.21 ± 0.45 | Not detected |
| 96 h | 20.55 ± 0.25 | Not detected | Not detected | Not detected |

It can be seen from Table 4 that, for fresh pork using the ordinary solution (Comparative Example 4), the TVB-N exceeded 15 mg/100 g and the APC exceeded 6 Log CFU/g at 48 hours, higher than that specified in the national standard; and fresh pork using the solution of the present disclosure could achieve a freshness lifetime up to 80 hours.

### Comparative Example 5

The cooling and cutting in step S1 of Example 1 was changed such that a pig carcass was slaughtered, cooled and aged for 24 hours, and then cut at 0° C. to 4° C.; and the rest operations were the same as in Example 1.

### Comparative Example 6

Comparative Example 6 was substantially similar to Example 1 except that the step S2 was canceled, and the 0° C. to 4° C. pork pieces obtained in step S1 were directly sub-packaged; and the rest operations were the same as in Example 1.

### Comparative Example 7

Comparative Example 7 was substantially similar to Example 1 except that the use of the insulation layer was eliminated, and the ice bag/meat weight ratio was changed to 1:1; and the rest operations were the same as in Example 1. Time for the fresh pork pieces of Example 1 and Comparative Examples 5 to 7 to reach the critical point of deterioration (TVB-N≥15 mg/100 g and APC ≥6 Log CFU/g) in 35° C. distribution was detected according to the above methods. The detection results are shown in Table 5.

TABLE 5
Time to reach the critical point of
deterioration in 35° C. distribution

| | | Comparative | Comparative | Comparative |
|---|---|---|---|---|
| Indicator | Example 1 | Example 5 | Example 6 | Example 7 |
| TVB-N ≥ 15 | 45 h | 36 h | 30 h | 24 h |
| mg/100 g | | | | |
| APC ≥ 6 Log | 52 h | 40 h | 28 h | 24 h |
| CFU/g | | | | |

It can be seen from Table 5 that the preservation method provided by the present disclosure greatly extends the time to reach the critical point of deterioration and effectively improves the freshness lifetime and shelf life of fresh meat in room temperature logistics by cutting while hot, cooling to 0° C. to 4° C. within 2 hours to 3 hours, cooling to a chilled/slightly-frozen state, and using an insulation layer of aluminum silicate fiber cotton.

During the shelf life, at the same time point, the fresh meat obtained in Example 1 has a color, taste and flavor that are superior to that of the fresh meat obtained in Comparative Examples 5 to 7.

The above description of examples is merely provided to help illustrate the method of the present disclosure and a core idea thereof. It should be noted that, several improvements and modifications may be made by persons of ordinary skill in the art without departing from the principle of the present disclosure, and these improvements and modifications should also fall within the protection scope of the present disclosure. Various modifications to these examples are readily apparent to persons skilled in the art, and the generic principles defined herein may be practiced in other examples without departing from the spirit or scope of the present disclosure. Thus, the present disclosure is not limited to the examples shown herein but falls within the widest scope consistent with the principles and novel features disclosed herein.

What is claimed is:

1. A preservation method for room temperature logistics of fresh meat, comprising the following steps:
(S1) cooling and cutting of fresh meat, including:
(a) cutting the fresh meat while the fresh meat is hot into meat pieces;
(b) cooling each of the meat pieces to a center temperature of 0° C. to 4° C. within 2 hours to 3 hours, each the meat pieces having a weight of 0.5 kg/piece to 1 kg/piece;
(S2) cooling the meat pieces to a chilled/slightly-frozen state, including:
(a) cooling the meat pieces to a center temperature of −4° C. to −2° C. so that the pork pieces reach a chilled/slightly-frozen state;
(S3) sub-packaging, including:
(a) placing a layer of absorbent pad at the bottom of a sub-packaging box;
(b) wrapping the meat pieces that have been cooled to the chilled/slightly frozen state; and
(c) conducting vacuum-packaging or modified atmosphere packaging (MAP) of the meat pieces;
(S4) packaging, including:
(a) providing one or more insulation foam packaging boxes having one or more walls,
wherein when ambient temperature is at least 24° C., the one or more walls of each of the insulation foam boxes has a thickness of 2 cm to 3 cm, an insulation layer being disposed on an inner surface of the insulation foam box,
wherein when ambient temperature is below 24° C., the one or more walls of each of the one or more insulation foam boxes has a thickness of 1.5 cm to 2 cm;
(b) placing the sub-packaging boxes containing the meat pieces into the one or more insulation foam packaging boxes together with ice bags, the ice bags and the meat pieces in the sub-packaging boxes having a weight ratio having a value of 2:1 to 1:1, a total volume of the ice bags and the sub-packaging boxes being 90% to 100% of a volume of the insulation foam box;
(c) when ambient temperature is below 24° C., putting the sub-packaging boxes containing the meat pieces into the one or more insulation foam boxes together with ice bags, the ice bags and the meat pieces in the sub-packaging boxes have a weight ratio having a value of 0.5:1 to 1:1, a total volume of the ice bags and the sub-packaging boxes with fresh pork pieces is 90% to 100% of a volume of the one or more insulation foam boxes;
(S5) logistics, including:
(a) using a room temperature logistics vehicle for transportation and distribution, wherein,
(b) when in ambient temperature is at least 24° C., transportation and distribution time is ≤36 h; and
(c) when ambient temperature is less than 24° C., the transportation and distribution time is ≤72 h.

2. The preservation method according to claim 1, wherein:
the absorbent pad comprises a wood pulp-wrapped polyethylene (PE)-super absorbent resin (SAR) mixture or nonwoven fabric-wrapped PE; and
the absorbent pad has a thickness of 0.1 cm to 0.3 cm.

3. The preservation method according to claim 1, wherein:
a packaging gas in the MAP has the following components, in volume percentage: 80% O₂, 15% CO₂, and 5% N₂; and the packaging gas in the MAP has a replacement rate ≥99.5%.

4. The preservation method according to claim 1, wherein:
the insulation layer has a thickness of 0.5 cm to 1 cm; and
the insulation layer is aluminum silicate fiber cotton.

5. The preservation method according to claim 1, wherein:
when the transportation and distribution time exceeds 16 h, a cooling treatment is conducted, the cooling treatment comprising:
opening the one or more insulation foam packaging boxes;
re-cooling the fresh pork pieces in sub-packaging boxes until the center temperature of the pork pieces is ≤4° C.; and
replacing the original ice bags with new ice bags and re-packaging the foam packaging box.

6. The preservation method according to claim 4, wherein:
when the transportation and distribution time exceeds 16 h, a cooling treatment is conducted, the cooling treatment comprising:
opening the one or more insulation foam packaging boxes;
re-cooling the fresh pork pieces in sub-packaging boxes until the center temperature of the pork pieces is ≤4° C.; and
replacing the original ice bags with new ice bags and re-packaging the one or more foam packaging boxes.
